(19) United States
(12) Patent Application Publication
(10) Pub. No.: US 2006/0111993 A1
(43) Pub. Date: May 25, 2006

(54) System, method for deploying computing infrastructure, and method for identifying an impact of a business action on a financial performance of a company

(75) Inventors: Richard Douglas Lawrence, Ridgefield, CT (US); Aleksandra Mojsilovic, New York, NY (US); Bonnie Kathryn Ray, South Nyack, NY (US); Samer Takriti, Croton-on-Hudson, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/994,260

(22) Filed: Nov. 23, 2004

(51) Int. Cl. G06Q 40/00

(52) U.S. Cl. 705/35

(57) ABSTRACT

A system (and method, and method for deploying computing infrastructure) for identifying the impact of a business action on a financial performance of a company, including performing a retrospective analysis of a plurality of example companies taking a business action, wherein the retrospective analysis is based on features of the plurality of companies in a predetermined pre-action time period and a predetermined post-action time period in the absence of definitive knowledge concerning when the impact will occur within the post-action time frame, and, moreover, predicting the impact of the business action on a new company.

### BACKGROUND OF THE INVENTION

1. Field of the Invention

The present invention generally relates to a system and method for financial analysis of business actions (such as C-level (e.g., “Chief”-level) officer changes, major restructuring, information technology (IT) outsourcing, etc.), and more particularly, to a system and method for identifying and/or quantifying an impact (e.g., a long-term impact) of a significant business action on the financial health of a company in the absence of definitive knowledge concerning when the impact will occur.

2. Description of the Related Art

As technology has continued to evolve, IT spending has become one of the dominant line items in companies' budgets. A large number of companies struggle to keep their IT investments up to date, to revitalize their legacy systems, optimize new investments and maintain current business practices, while keeping the IT spending under control. As a solution to this problem, many companies have made a decision to outsource a part of their IT operations. These services contracts are typically very expensive and represent a significant business decision for the company, for which they would like to be able to see measurable impact on their bottom line financials over the course of the investment.

However, the related art methods only look at the short-term effect of an action on the financial characteristics of the company, primarily at the effect on stock prices. Moreover, the related art methods assess impact at a pre-specified period, which in most cases is a short time after the action, e.g. one to six months. That is, the related art methods only consider the effects on the company for a short duration after the action and look for the effect at a pre-specified time period.

The related art methods are based on the theory of abnormal returns, which looks at how a company's stock returns correlate with, for example, the S&P 500 index before an event or action (i.e., before the company takes a particular business action). The related art methods determine the baseline correlation with the index. If the event had not occurred, then the assumption is that the company would have maintained the same correlation with the index. In other words, the related art looks to see whether there was an “abnormal” return, i.e. a large difference between the actual stock return after the event and the expected stock return if it maintained the same tracking with the index as it did prior to the event or action. Thus, the related art is disadvantageous because it only looks at, or is applied to, the stock returns of the company.

Moreover, the related art methods look for event impact at the same time period for all companies being analyzed. That is, the related art usually chooses a single time period at which to examine the difference between pre and post-event behavior and uses this time period to assess the impact for all companies. Additionally, the selected time period is usually specified to be a short time (e.g., 30 days to 6 months) after the event (see, for example, K. S. Im, K. E. Dow, V. Grover, “Research Report: A reexamination of IT investment and market value of the firm—an event study methodology”, Information Systems Research, 2001 INFORMS, vol. 12, no. 1, pp. 103-117, March 2001 or C. C. Y. Kwok and L. D. Brooks, “Examining event study methodologies in foreign exchange markets”, Journal of International Business Studies, Second Quarter 1990).

Thus, among other things, the related art methods cannot provide an accurate analysis or quantification of the effect of a business action on the broad financial health of the company (not reflected in the stock price), cannot allow for variable event impact timing across different companies, and further, cannot account for the long-term effects of such a business action on the financial health of the company. Moreover, they do not address the related issues of predicting the impact of an event on a company that is considering taking the specified business action, or the time at which that impact will be realized.

### SUMMARY OF THE INVENTION

In view of the foregoing and other exemplary problems, drawbacks, and disadvantages of the related art methods and structures, an exemplary feature of the present invention is to provide a system and method for providing an improved and more accurate system and method for identifying a significant impact (e.g., a long-term impact) of a business action on a company at an unspecified time point within a specified time window, including performing a retrospective analysis of a plurality of example companies taking the business action, wherein the retrospective analysis is based on features of the plurality of companies in a predetermined pre-action time interval (e.g., one to two years prior to the action) and a predetermined post-action time interval (e.g., one to five year after the action), without prior knowledge of the exact time period(s) within the post-action time window at which the impact will be optimally realized, with allowance for variation across individual companies. Moreover, a related exemplary feature of the present invention is to provide a system and method for predicting the impact of the business action on a company considering taking such an action, given characteristics of the company in the pre-action time frame, and the time period(s) in the post-event time frame at which this impact will be realized.

In one exemplary aspect, the step of performing the retrospective analysis includes identifying the plurality of companies taking the business action, and for each of the plurality of companies, identifying a date on which the business action occurred. In another exemplary aspect, the step of performing the retrospective analysis can include extracting the features for the plurality of companies in the predetermined pre-action time period and the predetermined post-action time period based on analysis of a metric of the plurality of companies. In another exemplary aspect, the step of performing the retrospective analysis can include determining, based on a mathematical algorithm, a feature value indicative of the impact in the predetermined post-action time period, and determining, based on a mathematical model, the impact of the action on the set of companies using a comparison between (e.g., difference in) the feature value in the post-action time period and the feature value in the pre-action time period.

In another exemplary aspect, the method predicts, based on a mathematical model, the impact of a planned business action on a company, given the feature values for the company in the time period prior to the planned action date.

In another exemplary aspect, the method can identify a known impact of a business action on a company and/or a known point in time at which the known impact was realized by the company and determine, based on a mathematical model, a starting point (e.g., starting date, starting time, etc.) of the business action by the company using a comparison between (e.g., difference in) a feature value in a post-action time period and another feature value in a pre-action time period.

In the exemplary aspects of the present invention, the company can include a set of companies (e.g., a plurality of companies), while the business action can include a plurality of business actions.

For each example company of the plurality of example companies, the exemplary aspects of the present invention also can include construction of a set of features during a pre-action time period and a post-action time period, and determination, based on a mathematical algorithm, of the time period within the post-action time period most indicative of the change in a metric of one of the example companies from the pre-action time period to the post-action time period. Further, the exemplary method can construct a mathematical model for assessing a significance of the most indicative change and for predicting a size of a difference as a function of a plurality of predetermined factors.

The feature value indicative of the impact can include a feature value indicative of at least one of a maximum impact and a minimum impact in the predetermined post-action time period, dependent on which is observed later in the post-event time period. The predetermined post-action time period can be based on a nature of the business action.

In another exemplary aspect of the present invention, the method for identifying an impact of a business action on a set of companies over a predetermined time period can include extracting features for a plurality of companies in a predetermined pre-action time period and a predetermined post-action time period based on an analysis of metrics of the plurality of companies, determining, based on a mathematical algorithm, a feature value indicative of an impact in the predetermined post-action time period, and determining, based on a mathematical model, the impact of the action on the set of companies using a comparison between (e.g., difference in) the feature value in the post-action time period and another feature value in the pre-action time period. The exemplary method can further predict, based on the mathematical model, an impact of a planned business action on a new company (e.g., a plurality of new companies).

The exemplary method can further include identifying the plurality of example companies taking the business action and, for each of the plurality of example companies, identifying a date on which the business action occurred.

The metric can include, among other things, a financial metric, a business metric, a management change, a merger, an acquisition, an earnings pre-announcement, a divestiture, a share repurchase, an expansion, a new market, a layoff, a reorganization, a restructuring, an initial public offering, a litigation, a governmental probe, a Securities and Exchange Commission (SEC) probe, and/or a regulatory probe, etc.

In one exemplary aspect, the predetermined pre-action time window includes a plurality of financial quarters prior to a financial quarter in which the action occurred. On the other hand, the predetermined post-action time window includes a plurality of financial quarters subsequent to a financial quarter in which the action occurred. The predetermined post-action time window also can include a plurality of financial quarters subsequent to a transition period following a financial quarter in which the action occurred. The transition period can include a predetermined period of time, based on the action, in which no impact of the action occurs.

According to the exemplary aspects of the present invention, the mathematical model can be designed by applying a statistical testing based on the set of example companies.

In another exemplary aspect of the present invention, a complementary predictive mathematical model can be designed to estimate the size of the impact for the set of example companies based on a plurality of features in the pre-action time frame. This mathematical model can be designed by applying a statistical or machine learning approach to-the set of example companies.

In another exemplary aspect of the present invention, a complementary predictive mathematical model can be designed to estimate the time period in the post-action window at which the impact will be realized, based on a plurality of company characteristics, such as industry and geographic location. This mathematical model can be designed by applying a statistical or machine learning approach to the set of example companies.

In another exemplary aspect, the method can include extracting, based on a predetermined date for at least one of a planned action and an expected action for the plurality of companies, a same set of features as the plurality of example companies, applying the predictive model to the extracted same set of features, and predicting, for each company of the plurality of companies, at least one of an expected impact of the action, an expected time of the expected impact of the action, and an expected size of the expected impact of the action, for each feature of the set of features. The plurality of example companies can be sorted, for example, based on the expected impact size and/or the expected time of impact, among other things.

According to the exemplary aspects of the invention, the plurality of predetermined factors can include a pre-action factor, a company specific factor, and/or an action-specific factor.

Another exemplary aspect of the invention relates to a system of identifying an impact of a business action on a set of companies over a predetermined time period. The system can exemplarily include an identifier that identifies the plurality of example companies taking the business action and, for each of the plurality of example companies, identifies a date on which the business action occurred, an extractor that extracts features of a plurality of example companies in a predetermined pre-action time period and a predetermined post-action time period based on analysis of metrics of the plurality of example companies, a determiner that determines, based on a mathematical algorithm, a feature value indicative of an impact in the predetermined post-action time period, a determiner that determines, based on a mathematical model, the time period within the post-event time window at which to measure the impact of the business action, a determiner that determines, based on a mathematical model, the impact of the action on the set of companies based on a comparison between (e.g., difference in) the feature value in the post-action time period and another feature value in the pre-action time period to determine, a predictor that predicts, based on a mathematical model, an impact of the business action on a new company, and a predictor that predicts, based on a mathematical model, the time at which the impact of the business action will be realized for a new company.

In another exemplary aspect of the invention, the system includes an extractor that extracts features of a plurality of example companies in a predetermined pre-action time period and a predetermined post-action time period based on analysis of metrics of the plurality of example companies, an identifying unit that identifies a known impact of the business action on the company and/or a known point in time at which the known impact was realized by the company, and a determiner unit that determines, based on a mathematical model, a starting point (e.g., a starting time, starting date, implementation, etc.) of the business action by the company using a comparison between (e.g., difference in) a feature value in the post-action time period and another feature value in the pre-action time period.

In another exemplary embodiment, the system of identifying an impact of a business action on a set of companies over a predetermined time period can include means for extracting features of a plurality of example companies in a predetermined pre-action time period and a predetermined-post-action-time period based on analysis of metrics of the plurality of example companies, means for determining, based on a mathematical algorithm, a feature value indicative of an impact in the predetermined post-action time period, means for determining, based on a mathematical model, the time period within the post-action time frame at which the impact is realized for a feature value, means for determining the impact of the action on the set of companies based on a comparison of the feature value at the determined time period in the post-action time period and the feature value in the pre-action time period, means for predicting, based on a mathematical model, an impact of the business action on a new company, and means for predicting, based on a mathematical model, the time at which the impact of the business action will be realized on a new company.

Another exemplary aspect of the invention includes a signal-bearing medium tangibly embodying a program of machine-readable instructions executable by a digital processing apparatus to perform a method (as described herein) for identifying an impact of a business action on a set of companies over a predetermined time period. On the other hand, an exemplary aspect of the present invention is directed to a method (as described herein) for deploying computing infrastructure in which computer-readable code is integrated into a computing system, and combines with the computing system to perform a method for identifying an impact of a business action on a set of companies at an unknown time point within a predetermined time period.

As mentioned above, organizations are increasingly outsourcing non-core components of their businesses. The decision to outsource a large portion of a company's infrastructure, such as their information technology (IT) is a significant one. As such, it is desirable to be able to measure the effect of such an action on the financial characteristics of the company. However, the related art approaches to quantifying the impact of a significant business action have typically focused on the immediate effect of the action on a single metric, primarily the company's stock price, i.e., looking for a change in the stock price from what would be considered “normal” behavior within a few weeks or months of the action. A key deficiency in this approach, however, is that it does not allow for variable timing of an action's effect when considering the impact on a set of companies. It also assumes that the impact of the action will be reflected only in the stock price, not necessarily in a broader range of financial metrics. That is, by assuming a common time frame for determining the impact of an action across a set of companies, the related art approach could result in an understatement of the action's effect if the wrong time period is chosen to assess the impact on a particular company.

Additionally, the related art methods do not assess other factors about the company which may affect the size of the business action's impact on the financial health of the company. Such factors can include, but are not limited to, the industry in which the company operates, the company size, and the financial characteristics of the company immediately prior to the business action.

The present invention overcomes the problems, drawbacks, and disadvantages of the related art methods and structures. For example, the exemplary aspects of the present invention can provide a methodology for measuring the impact (e.g., long-term impact) of a business action along different dimensions of the business, allowing for differences in the way the impact may be manifested over time for different companies. Additionally, the exemplary aspects of the present invention provide a systematic means for predicting the impact of a planned action on a new company, given high-level characteristics of the company and financial information about the company immediately prior to the action. Moreover, the exemplary aspects of the present invention provide a systematic means for predicting the time period at which the impact of the action will be realized.

Unlike the related art, the exemplary aspects of the present invention can provide a process or methodology for measuring the impact of a business action on a set of companies for the purpose of identifying companies (businesses or accounts) that have an increased sensitivity to the business action.

Moreover, the exemplary method of the present invention has advantages over the related art in that it is, for example, capable of identifying and/or quantifying the impact of a business action prior to the action and/or at some point after the action has been taken. That is, unlike the related art, the novel invention can determine what impact a business action will have (or has had) on the company's financial health, determine the timing (e.g., point in time or duration) of the impact, and/or quantify the size of the impact.

Moreover, unlike the related art methods, the present invention can look at the long-term effects of the business action on the financial health of the company. In other words, the present invention is capable of looking at the long-term effects, as well as the short-term effects, to determine whether such outsourcing will affect the financial health of the company in the long-term, as opposed to looking only at the short-term effect on stock prices, as with the related art methods.

Moreover, the present invention does not restrict the example companies to the same timing (e.g., 2 years, 2½ years, etc.). Instead, the present invention is capable of providing an analysis based on variable timing on a company-by-company basis. Accordingly, because the time period can include all of the variations in time for each of the sample companies, the present invention allows the timing to be variable across the set of example companies. Thus, it is possible to characterize the time period and/or predict the time period. This is beneficial because not all companies feel the impact, for example, of outsourcing, at the same time.

Moreover, the present invention is capable of determining when the optimal time or impact occurred. This also is beneficial because there may be a difference in the optimal timing in the particular industry to which the company belongs, or for that particular service provider.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a flow diagram of a method 100 according to an exemplary, non-limiting embodiment of the present invention;

FIG. 2 illustrates an exemplary list of financial metrics and computed features from these financial metrics to be used as input to a mathematical model according to an exemplary aspect of the invention;

FIG. 3 illustrates an exemplary list 300 of corporate developments to be used as input to the mathematical model according to an exemplary aspect of the invention;

FIG. 4 depicts a graph 400 illustrating specification of pre- and post-event time windows;

FIG. 5 depicts a graph 500 illustrating an exemplary method for determining most substantive impact of action for a particular company;

FIG. 6 illustrates an exemplary apparatus 600 according to an exemplary, non-limiting embodiment of the present invention;

FIG. 7 illustrates an exemplary hardware/information handling system 700 for incorporating the present invention therein; and

FIG. 8 illustrates a signal bearing medium (e.g., storage medium 800) for storing steps of a program of a method according to the present invention.

### DETAILED DESCRIPTION OF EXEMPLARY EMBODIMENTS OF THE INVENTION

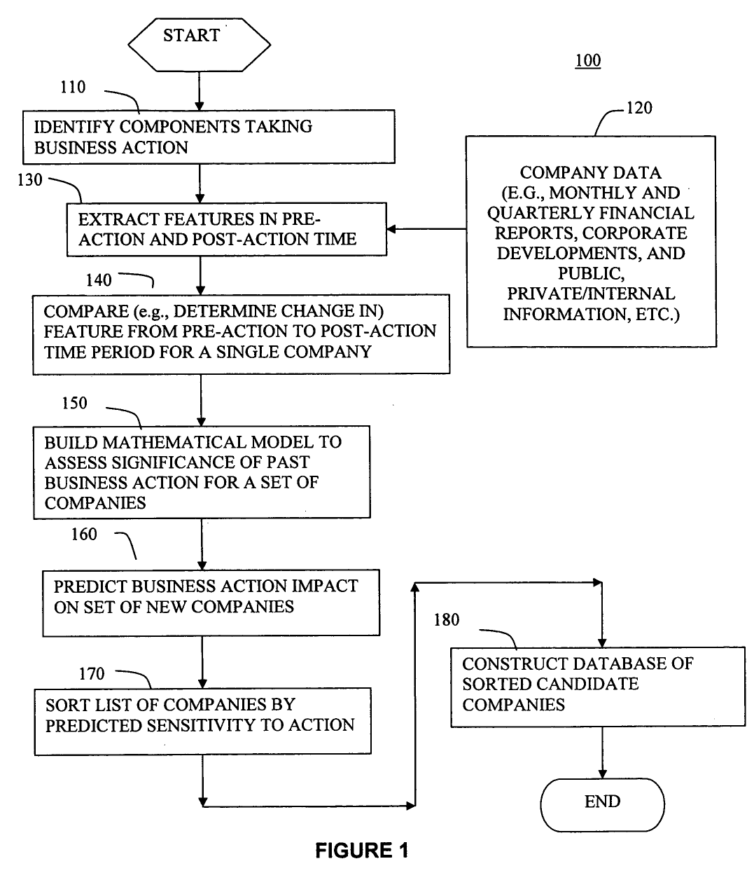

Referring now to the drawings, and more particularly to FIGS. 1-8, there are shown exemplary embodiments of the method and structures according to the present invention.

The present invention generally relates to a system and method for financial analysis of business actions (such as C-level (e.g., “Chief”-level) officer changes, major restructuring, information technology (IT) outsourcing, etc.), and more particularly, to a system and method for identifying and/or quantifying a long-term impact of a significant business action on the financial health of a company.

Over the last 10 years these has been an explosion in services business outsourcing (e.g., IT outsourcing and business process/method outsourcing). Many of these services contracts are large and represent a significant multi-year revenue stream for the service provider (e.g., in excess of $30B/year for some companies). As a result, service providers are eager to gain a competitive advantage by having the capability to quantify the long-term impact that a services engagement will have on a client's financial performance, and subsequently, marketing and tailoring their services to clients for whom the services engagement will have the most positive impact on a set of desired metrics within some specified time frame.

Referring now to the drawings, and more particularly to FIG. 1, there is shown a preferred, exemplary aspect of a method 100 for determining the impact of a significant business action on a set of companies, using IT outsourcing as exemplary action.

In FIG. 1, the method 100 includes identifying (e.g., function block 110) example companies that have engaged in an outsourcing arrangement. An “example” is uniquely defined by the identity of a company and the date on which information for this example is valid. These examples can be obtained from publicly available news filings describing outsourcing deals using, for example, data mining techniques. On the other hand, non-public, internal, or proprietary information also may be used. The name of the company that signed the contract, and the date of the signing, uniquely defines an example.

The publicly available information (and/or non-public, internal, or proprietary information) (e.g., see function block 120) on each of the companies can include, for example, monthly stock price, quarterly Securities and Exchange Commission (SEC) filings, credit ratings, executive management changes, and other corporate developments such as mergers and acquisitions. The data can be acquired, for example, from various data providers (or, if accessible, from the companies themselves), and imported into a single database holding all such data for all of the examples.

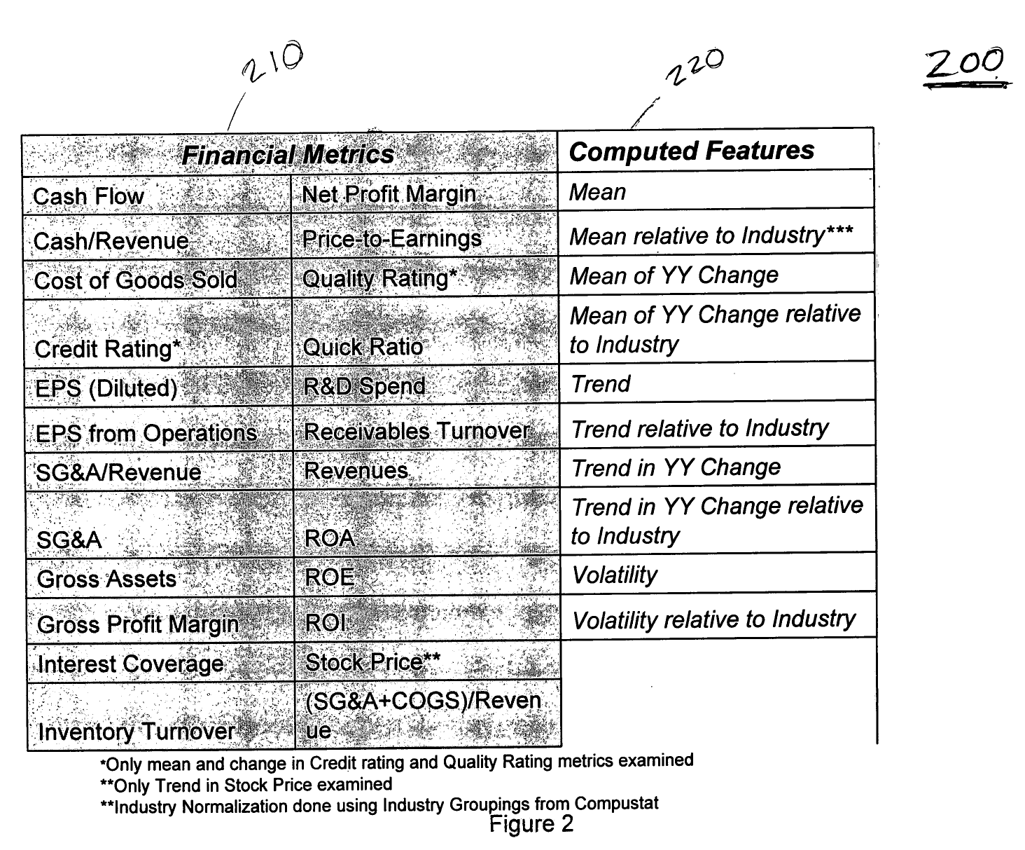

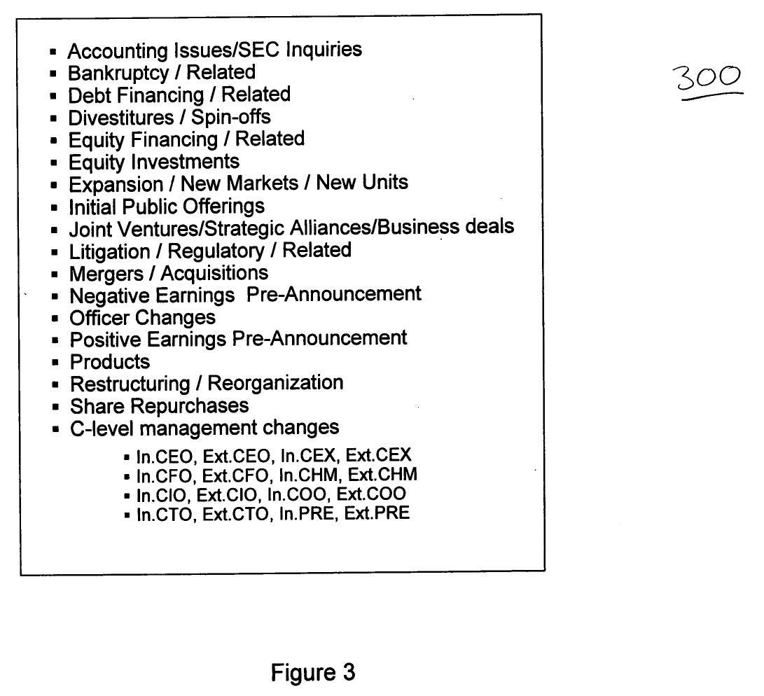

As shown in exemplary aspect of FIG. 1, the function block 130 represents the process of reducing the information defined in function block 120 to obtain a set of metrics or explanatory “features” in the pre-action and post-action time periods (i.e., pre-event and post-event time frames), which can be used as an input (or inputs) to a mathematical model (e.g., see function block 140) designed to determine an impact of outsourcing on the financial health of a set of example companies. An exemplary set of financial metrics 210 and computed features 220 is shown in the list 200 of FIG. 2. An exemplary set 300 of corporate developments is shown in FIG. 3.

The exemplary aspects of the present invention, as described herein, use information technology (IT) outsourcing as an example for clarifying the subject of the illustrative, non-limiting aspects of the present invention. However, it is important to note that the exemplary systems and methods according to the exemplary aspects described herein are generally applicable and can be applied to identify and/or quantify the impact of any significant business action, such as a change in executive leadership of the company, major restructuring or reorganization, etc.

As mentioned above, IT spending has become one of the dominant line items in companies' budgets. A large number of companies struggle to keep their IT investments up to date, to revitalize their legacy systems, optimize new investments and maintain current business practices, while keeping the IT spending under control. As a solution to this problem, many companies have made a decision to outsource a part of their IT operations. These services contracts are typically very expensive and represent a significant business decision for the company, for which a company would like to be able to see a measurable impact on their bottom line financials over the course of the investment.

Generally, such an action will impact reported financial metrics for the company, such as the Return on Investment (ROI) or Gross Profit Margin (GPM). However, because of the nature of the contracts, such an impact generally will not be detectable immediately. Instead, the impact will develop over the course of the initial years of the contract as the new IT initiatives are put into place. Different companies may also experience differing impacts, and at different times after the contract begins, depending on, for example, the nature of their core business.

As mentioned above, related art approaches to quantifying the impact of a significant business action have typically focused on the immediate effect of the action on a single metric, primarily the company's stock price, i.e., looking for a change in the stock price from what would be considered “normal” behavior within a few weeks or months of the action. A key deficiency in this approach, however, is that it does not allow for variable timing of an action's effect when considering the impact on a set of companies. It also assumes that the impact of the action will be reflected only in the stock price, not necessarily in a broader range of financial metrics.

That is, by assuming a common time frame for determining the impact of an action across a set of companies, the related art approach could result in an understatement of the action's effect if the wrong time period is chosen to assess the impact on a particular company.

Additionally, the related art methods do not assess other factors about the company which may affect the size of the business action's impact on the financial health of the company. Such factors can include, but are not limited to, the industry in which the company operates, the company size, and the financial characteristics of the company immediately prior to the business action.

On the other hand, the exemplary aspects of the present invention can provide a methodology for measuring the impact (e.g., long-term impact) of a business action along different dimensions of the business, allowing for differences in the way the impact may be manifested over time for different companies. Additionally, the exemplary aspects of the present invention provide a systematic means for predicting the impact of an action on a company, given high-level characteristics of the company and financial information about the company immediately prior to the action. Moreover, the exemplary aspects of the present invention provide a systematic means for predicting the time at which the impact of an action on a company will be realized, given high-level characteristics of the company.

The exemplary aspects of the present invention provide a process or methodology for measuring the impact of a business action on a set of companies for the purpose of identifying companies (e.g., businesses or accounts) that have an increased sensitivity to the business action.

For example, as described in detail below, the present invention can provide a retrospective analysis of a set of companies that have taken some business action (e.g., a large IT outsourcing engagement). The present invention is capable of identifying and/or quantifying the impact of that business action based on a set of metrics (e.g., one or more metrics). For example, the exemplary method can quantify the impact on a company's return on assets (e.g., quantify the difference the IT outsourcing had on the company's assets).

The exemplary method of the present invention is capable of identifying and/or quantifying the impact of a business action prior to the action and/or at some point after the action has been taken. That is, the novel invention can determine what impact a business action will have (or has had) on the company's financial health, determine the timing (e.g., point in time or duration) of the impact, and/or quantify the size of the impact.

Moreover, unlike the related art methods, the present invention can look at the long-term effects of the business action on the financial health of the company. In other words, the present invention is capable of looking at the long-term effects, as well as the short-term effects, to determine whether such outsourcing will affect the financial health of the company in the long-term, as opposed to looking only at the short-term effect on stock prices, as with the related art methods.

For example, in comparison with the related art methods, the present invention uses a much larger time frame, including a transition period after the action takes place to permit the action to be implemented, thereby obtaining a more accurate quantification of the impact of the action on the financial health of the company. If, for example, the business action has a large impact after a couple of years and then declines, it would not be beneficial to use the maximum impact, which occurred shortly after the action. Instead, according to the exemplary aspects of the present invention, it may be more beneficial to use the minimum impact if the minimum impact occurs later in time than the maximum impact.

Moreover, the present invention does not restrict the example companies to the same timing (e.g., 2 years, 2½ years, etc.). Instead, the present invention is capable of providing an analysis based on variable timing on a company-by-company basis. That is, the present invention can take the maximum impact or minimum impact for each sample in the sample set, depending on which occurs later in time. Accordingly, because the time period can include all of the variations in time for each of the sample companies, the present invention allows the timing to be variable across the set of example companies.

Thus, in contrast to the related art methods, the present invention does not employ the abnormal return methodology based solely on stock prices in a short time window after the event. Instead, the exemplary aspects of the present invention look at the difference between a very broad range of metrics for a company at variable time points in a long time window after the event.

The exemplary aspects look at some predetermined time period or time frame (e.g., a long-term time window) after a business action or event, using variable timing for each example company, compares the metric in that time window with the value of the metric prior to the action or event, quantifies that difference, and models that difference as a function of some factors. The present invention looks at pre-action and post-action time frames and allows for variable timing for different companies. Thus, the present invention does not limit the determination of impact effect to a particular point in time.

The impact of the event on the company can depend on how the company was performing prior to the action, on the industry of the company, and/or on other factors which are known before the action takes place (e.g., actual predictive modeling).

The retrospective analysis according to the present invention can be applied in a predictive manner to another company that is now considering taking such an action (e.g., the same or similar action). That is, if the characteristics of a company are known today, the present invention can predict the impact that an action or event will have on that company. The present invention can also be applied in a predictive manner to another company to determine the time at which the impact of the action will be realized.

An exemplary aspect of the present invention can provide three different analysis. First, a set of example companies can be analyzed to determine whether there has been a significant change from the post-action time period to the pre-action time period. Second, the present invention can determine what factors influenced the size of the differences that are determined. Third, the present invention can determine what factors influenced the time at which the largest/smallest impact was realized. For example, the present invention is capable of determining whether it was the overall financial health of the company in the pre-action time period, whether it was the industry that the company is in, etc.

In the outsourcing example mentioned above, the present invention can determine whether the impact is a result of which provider the company chose to outsource with, and how those factors influenced the size of the measured difference from the post-action time frame to the pre-action time frame.

The exemplary aspects of the present invention can build a model that can be used for predictive purposes. For example, a new company is considering outsourcing with company A or company B. The new company knows a set of metrics that characterize its financial health right now. If the new company were to outsource with company B, then the present invention can predict how that action will affect the long-term impact on assets of the new company.

As mentioned above, the present invention is capable of realizing the impact over different time periods for each company. Thus, it is possible to characterize the time period and/or predict the time period. This is beneficial because not all companies feel the impact, for example, of outsourcing, at the same time. For example, a financial company may feel the impact of outsourcing quicker than a consumer products company.

Moreover, the present invention is capable of determining when the optimal time or impact occurred. This also is beneficial because there may be a difference in the optimal timing in the particular industry to which the company belongs, or for that particular service provider.

As would be understood by the ordinarily skilled artisan, the timing can be dependent on the nature of the impact, the particular metrics that are being used, etc. Also, the timing can be tied to the granularity of the metrics. For example, if monthly, quarterly, or yearly data is being used, the timing can be monthly, quarterly, and yearly, respectively.

As mentioned above, the transition period following the time of the action can be dependent on the nature of the action that the company is taking. For example, in the outsourcing example, there will be some start-up time during which the company is in the process of switching over to the outsourcing company or provider. Accordingly, until the process of switching over has been completed, an impact on the financial health of the company may not be detectable. That is, one would not expect to see any impact on the company or its financials until the transition is completed, which may be one to two years after the outsourcing arrangement is announced. The impact of the outsourcing event on the company's financials would then be determined in the two to five year window after the beginning of the outsourcing event. For other events, such as management changes, the impact of the event may be realized within a shorter time frame. Thus, the determination of what is considered long-term is action dependent and can be specified by an expert in matters related to the business action.

In addition to determining the size of the impact on a company or set of companies, the present invention can determine what factors or features effect the size of the impact, can determine when the impact will occur (or has occurred), and/or can sort the factors or features based on the size of the impact or time of the impact, etc.

The maximum to minimum size of the impact can be determined over a range of time. The time periods at which the maximum and minimum occur can be defined as tₘₐₓ and tₘᵢₙ. The size of the impact may be gradually increasing, in which case the largest impact (tₘₐₓ) would occur most recently. On the other hand, the size of the impact may gradually decrease over time, in which case the smallest impact (tₘᵢₙ) would occur most recently.

The present invention generally uses the tₘₐₓ or tₘᵢₙ which occurred most recently, since it is trying to predict the long-term impact. Thus, the present invention is capable of sorting out inconsistencies and occurrences and does not bias the analysis by always using the peak (e.g., maximum). Thus, the present invention can avoid the problems associated with determining larger, long-term impacts than may really have occurred and can more accurately and reliably predict a long-term impact of a business action on the financial health of a company or set of companies.

The present invention can provide a model for determining how or what factors may affect the size of a particular metric or feature as a result of a particular business action. The companies can be sorted based on which companies are more sensitive to certain features.

The model according to the invention can be applied to a new company to predict how such an action will affect (e.g., positively, negatively, or no change) the new company's return on long term assets if the new company takes such an action. The model according to the invention can be applied to a new company to also predict the time point at which the long-term effect can be said to have occurred.

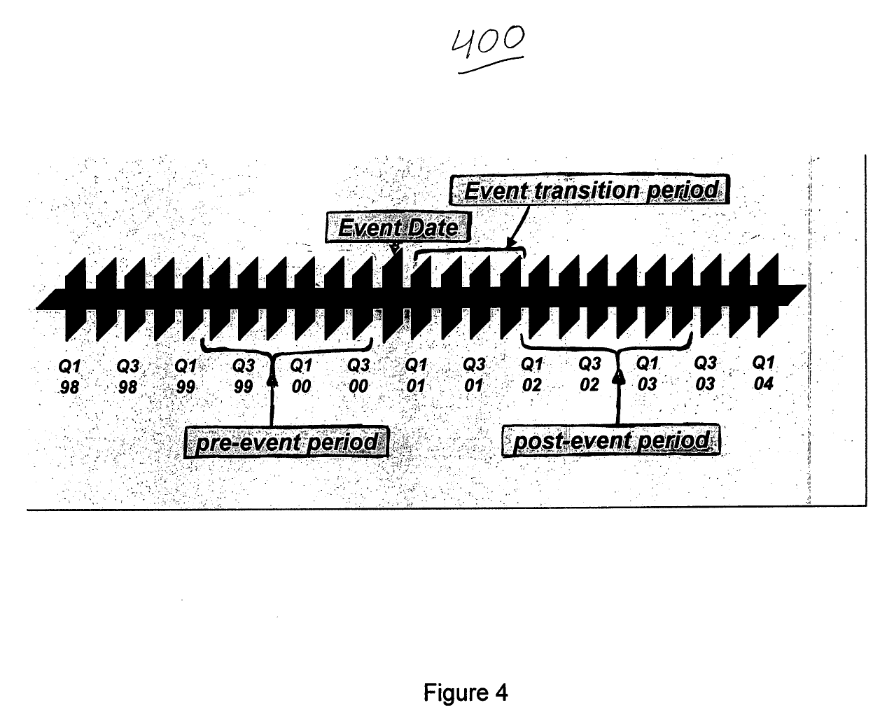

Referring to the Figures, FIG. 4 shows an exemplary method for defining pre-action and post-action time periods (i.e., pre-event and post-event time windows/frames). In such an example, the quarter in which the business action occurred is shown by the event date. The pre-event time period (i.e., time window or frame) may be defined, for example, as the six (6) quarters prior to the quarter in which the business action occurred.

An event transition period may be defined, for example, as the four (4) quarters immediately following the event. The transition period is used to allow for time periods in which no impact of the event is expected to occur, due to, in the outsourcing example, a start-up period in which the client is transitioning their infrastructure to the outsourcing provider.

The post-event time window is defined, for example, as the six (6) quarters after the end of the transition period. These periods are chosen to provide the most information about the health of the company immediately prior to the business action, as compared to the health of the company in the 2-3 years after the business action, i.e. to study the “long-term” impact of the action on the financial health of the company. Based on the selection of these event periods, features such as counts, trends and averages, year-to-year changes, and volatility are computed for each quarter of the pre-event and post-event time windows (i.e., pre-action and post-action time periods), based on financial metrics and corporate developments over the previous four (4) quarters.

For example, after an event (i.e., action), the exemplary aspects of the present invention can look for a peak impact (e.g., an improvement or decline) relative to the industry, respectively. In the post-event window, the present invention can find the time period at which the company deviation from the industry is largest (e.g., tₘₐₓ) and the smallest (e.g., tₘᵢₙ). If tₘₐₓ is more recent than tₘᵢₙ, then the action may result in a gradually increasing impact. On the other hand, if tₘᵢₙ is more recent than tₘₐₓ, then there may have been an early, large impact as a result of the action, with a decrease to a stable, sustainable impact.

In other words, an exemplary aspect of the present invention can look at any time period after the action has taken place, find the point in time in which the difference between the performance for the company and the performance for the entire set of example companies (e.g., in the same industry) is the largest and what point in time the difference is the smallest.

If the point in time that is the largest comes after the point in time that is the smallest, then the exemplary method uses the largest (i.e., maximum) as the metric to compare to the time period prior to the action.

On the other hand, if the point in time that it the smallest (i.e., minimum) comes after the maximum, then the exemplary method uses the minimum.

The mean refers to the average of the features (e.g., the monthly close of the stock price, the quarterly earnings per share, etc.) during the time window/frame/period. The trend refers to the normalized slope of the respective feature.

Note that it is not necessary to specify the same pre-event and post-event time windows for all metrics.

Returning again to FIG. 1, function block 140 represents the process/method for determining the long-term impact of a business action or actions on a particular feature for a company. Any appropriate algorithm for determining the post-event feature value may be used.

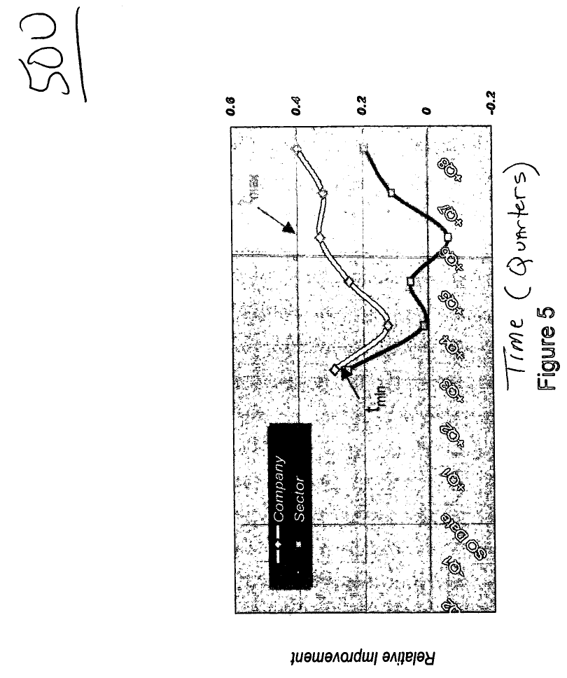

An exemplary algorithm for determining the post-event feature value is shown in FIG. 5. In this exemplary algorithm, the time period is found at which the maximum and minimum differences between the feature for a particular company and the average feature value for all companies in the same sector occurs. The deviation occurring later in time is determined to be the most indicative of the long-term impact of the business action on the financial metric for that company. There are no known commercially available packages/algorithms that implement exactly the computation described for determining the time point at which the peak impact is realized. However, an implementation of the exemplary algorithm can be created using standard mathematical programming tools, such as Matlab.

Function block 150 represents the process of building a mathematical model to assess the size of the business action impact. An exemplary method for determining the size of the long-term impact is using a Student's t-statistic to test whether the difference in the deviations from sector average in the pre-event and post-event time windows is significantly different from zero. The present invention is not limited, however, to this method. Other methods can of course be used, such as linear regression method to characterize the size of the difference as a function of company characteristics, such as industry, market capitalization, etc., as well as the financial health of the company in the pre-event time frame, as characterized by the financial and corporate development-based features described in 130.

Function block 160 represents the process of using the mathematical model described in 150 to predict the size of impact of a business action on a new set of companies, given a presumed date for the action and a set of company characteristics.

Returning again to FIG. 1, function block 170 forms a prioritized list of companies by sorting the candidate companies by the predicted impact of the business action, using the output of block 160. The companies with the largest predicted impact may be exemplarily listed at the top of the list.

Function block 180 includes constructing a database of the sorted candidate companies to facilitate marketing to the most promising client or company. Other criteria may of course be used in combination with predicted impact to form prioritized marketing lists within the spirit and scope of the appended claims.

The exemplary aspects of the present invention provide a process or methodology for measuring the impact of a business action on a set of companies for the purpose of identifying companies (businesses or accounts) that have an increased sensitivity to the business action.

For a given set of businesses, an exemplary aspect of the invention may be summarized as follows.

In a first step according to an exemplary feature of the present invention, a company's past actions can be evaluated by constructing a set of examples of companies that have taken a particular business action (or set of actions).

In a second step, for each example, during a pre-event and post-event time window, a set of features can be constructed, which may include, but are not limited to: (a) financial and business performance metrics, and/or (b) news-based metrics on significant happenings in client's company, etc.

In a third step, a mathematical algorithm can be applied to find the most substantive long-term change in the company's metrics from a pre-event time window to a post-event time window.

In a fourth step, a mathematical model can be constructed to: (1) assess the significance of the measured long-term change (2) estimate the size of the difference as a function of various pre-event, company specific, or action-specific (e.g., outsourcing provider) factors, and (3) estimate the time point at which the long-term difference will be realized.

The exemplary model can be designed by applying a statistical or machine learning approach on the aforementioned set of examples.

In a fifth step of predicting for planned actions, given a date for a planned or expected action for a new set of companies, a set of features (e.g., exactly the same set of features) can be extracted as in the second step above.

In a sixth step, the predictive models of the fourth step set forth above can be applied to the extracted features and the expected impact of the action along each of the dimensions of interest can be computed, along with the expected time period at which the impact of the action will be realized.

In a seventh step, the set of companies can be sorted to answer questions such as: (1) which are the companies most likely to benefit from the action, (2) how soon is a particular company likely to observe an impact, etc.

In the example set forth above, with respect to outsourcing as the business action, the user of the exemplary method or process according to the present invention may be:
(a) a company executive in charge of determining whether his business would benefit from outsourcing;
(b) a decision maker within an organization that is interested in marketing its outsourcing services to potential customers; and
(c) an intermediary who brokers outsourcing deals between customers and providers; or
(d) a market intelligence agency that is interested in comparing and valuing companies in terms of outsourcing sensitivity.

In the exemplary case of the IT outsourcing example, the outsourcing providers can include such companies as Accenture, Computer Sciences Corp. (CSC), Electronic Data Systems (EDS), and Hewlett-Packard (HP), etc.; and the intermediaries can include companies such as TPI, etc.; and the market intelligence agencies include Gartner Group, Metagroup, and Forrester, etc.

It is important to emphasize that the exemplary aspects described herein are not limited to determining the sensitivity of a company towards outsourcing (or other business actions) retrospectively. The exemplary aspects of the invention described herein can be also used to predict the sensitivity of a company towards outsourcing, given its current financial condition and other high-level characteristics of the company.

As described and used in the exemplary aspects of the present invention, the metrics on which the outsourcing may impact can include, for example, stock price, cash flow, gross profit margin, return on assets, expenses, revenue, receivables turnover, earning per share, return on equity, and/or inventory turnover, etc. The factors influencing the impact of the action can include, for example, diversification, spending, industry sector, and/or previous financial health, etc.

While the invention is exemplarily described with respect to these exemplary services, those skilled in the art will recognize that the invention is not limited to the exemplary embodiments and can be applied to address any type of business relationship.

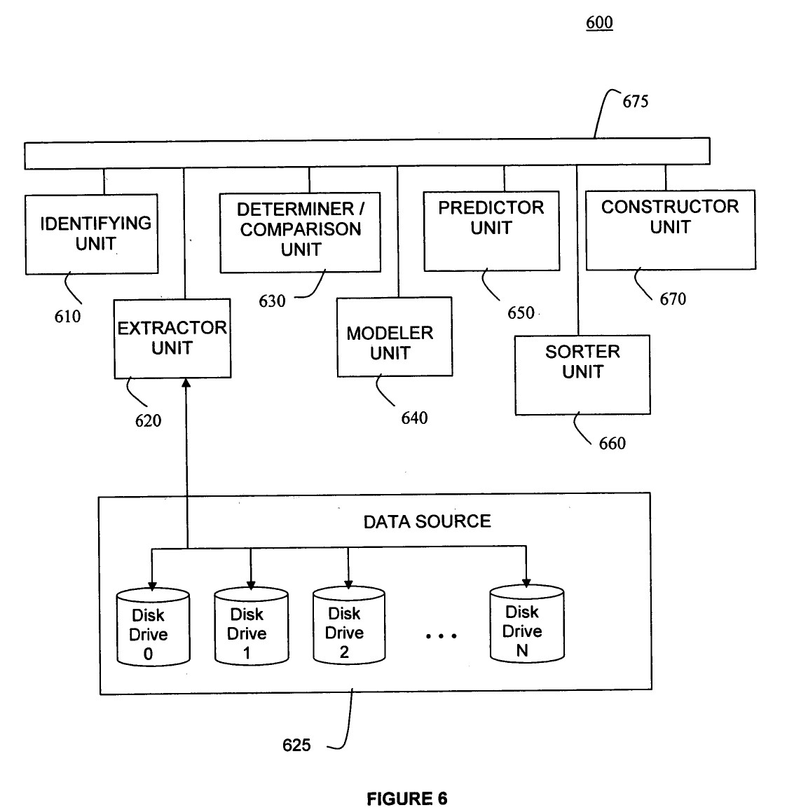

FIG. 6 illustrates an exemplary system 600 according to the present invention that is capable of providing the additional features and advantages described above. For example, a system according to the claimed invention may include an identifying unit (e.g., 610) for identifying a plurality of example companies taking a business action and, for each of the plurality of example companies, identifying a date on which the business action occurred.

The system 600 also can include an extractor unit (e.g., 620) that extracts features of the plurality of example companies (e.g., from data source 625, which can include, for example, an array of disks 0 to N) in a predetermined pre-action time period and a predetermined post-action time period based on analysis of metrics of the plurality of example companies.

A determiner unit (e.g., 630) determines, based on a mathematical algorithm, a feature value indicative of an impact in the predetermined post-action time period. The same, or another, determiner unit or modeler unit (e.g., 640) determines, based on a mathematical model, the impact of the action on the set of companies based on a comparison between (e.g., difference in) the feature value in the post-action time period and another feature value in the pre-action time period to determine.

A predictor unit (e.g., 650) predicts, based on a mathematical model, an impact of the business action on a new company and the time of the impact. A sorter unit (e.g., 660) can sort the plurality of companies (e.g. set of companies) based on the impact of the action, the timing of the impact, the quantification of the impact, and/or the sensitivity of each company to the action. A constructor unit (e.g., 670) can construct a database of sorted candidate companies' relationships between the companies. These units may be coupled together by a connector unit 675, such as a bus, a network (e.g., worldwide or local area), or the like.

In another aspect of the invention, the identifying unit (e.g., 610) can identify a known impact of a business action on a company and/or a known point in time at which the known impact was realized by the company. The determiner unit (e.g., 630) can determine, based on a mathematical model, a starting point of the business action by the company using a comparison between (e.g., difference in) a feature value in the post-action time period and another feature value in the pre-action time period. On the other hand, the determiner unit (e.g., 630) can determine, based on a mathematical model, a significance of the starting point of the business action by the company on the impact to the company.

Thus, the exemplary aspects of the system (and method) according to the present invention also can look backwards in time to determine the start time of a business transformation that lead to a known impact on the business and the significance of that start time on the impact to the company.

The present invention exemplarily provides a method for determining (e.g., retrospectively) whether there is an impact, a model for predicting a size of an impact on a new company, given company specific, pre-event characteristics, and/or a model for predicting a time point at which a long-term impact will be realized for a new company, etc.

As mentioned above, in an exemplary aspect of the present invention, an event date is known. The exemplary aspect looks forward in time over some pre-specified time window to determine the impact of that event. The impact can be measured by comparing the value of some metric in the pre-event time window to the value of that metric in some time point in the post-event time window. The time point at which the measurement is taken is not known. Therefore, to determine the time point, the exemplary aspect looks for the time point at which the difference between the pre-event metric value and the post-event metric value is largest or smallest, depending on which comes later in time.

On the other hand, it would be understandable to the ordinarily skilled artisan that the present invention also can provide a methodology looking backwards in time to determine a starting point for a business transformation, given a specified date at which the transformation has been achieved, but knowledge of that starting point is not explicitly known.

That is, if the specified date at which the transformation (or some other business event) has been achieved (e.g., the transformation has been completed, the impact has been realized, etc.) is known, but the starting point or time of the transformation (e.g., the exact starting date) is not known, an exemplary aspect of the present invention can look backwards in time to determine the starting point for the business transformation.

For example, if a company has been determined to have achieved an advanced level of providing business services (e.g., computing), but it is not known exactly when the company started the process of moving to provide these business services, an exemplary aspect of the invention can look backwards in time over a predetermined time window and look for the maximum or minimum comparison between (e.g., a difference in) a metric that is observed now (e.g., at the time that it is determined to be an advanced level of transformation) relative to the value of the metric at some time point in the predetermined time window before the business transformation was achieved.

In other words, the exemplary aspect looks backwards in time over a predetermined time window for the time points within the window at which the maximum and minimum impacts occur and uses whichever one of the maximum or minimum comes earliest in time. The impacts are measured relative to the known, realized event impact date.

This exemplary aspect provides a methodology for identifying or determining the time point at which the transformation began and for determining (e.g., measuring, assessing, etc.) the significance of the impact of that transformation.

Yet another exemplary embodiment of the present invention includes a signal-bearing medium (e.g., 800) tangibly embodying a program of machine-readable instructions executable by a digital processing apparatus to perform a method for identifying an impact of a business action on a set of companies over a predetermined time period, in which the method includes the features as described above.

Still another exemplary aspect of the present invention includes a method for deploying computing infrastructure in which computer-readable code is integrated into a computing system, and combines with the computing system to perform a method for deploying computing infrastructure in which computer-readable code is integrated into a computing system, and combines with the computing system to perform a method for identifying an impact of a business action on a set of companies over a predetermined time period, in which the method includes the features as described above.

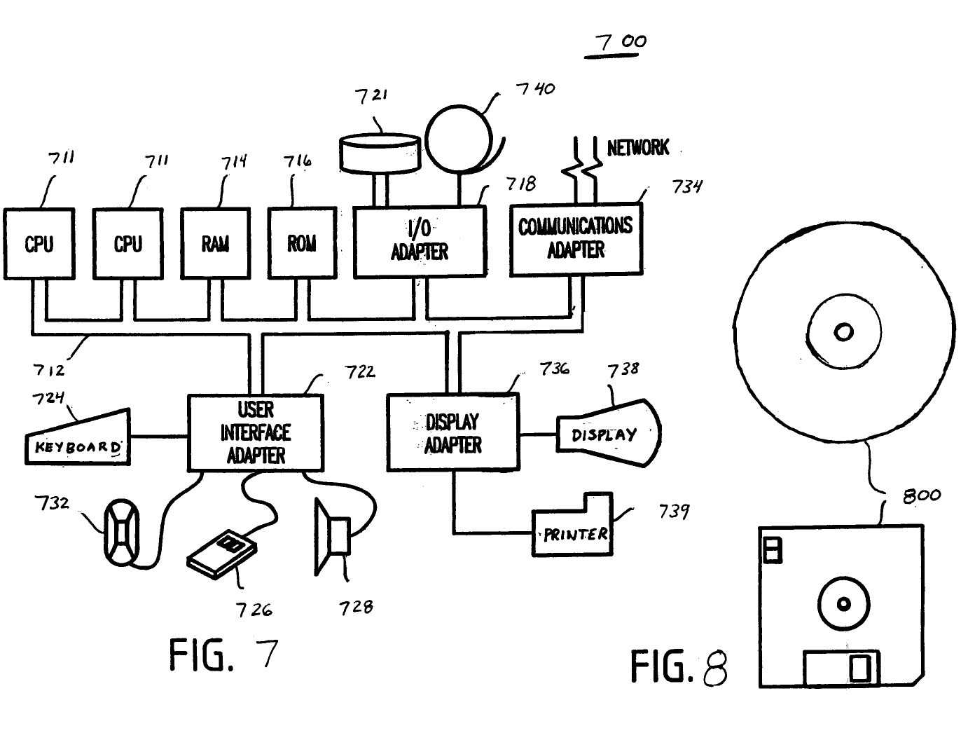

FIG. 7 illustrates an exemplary hardware/information handling system 700 for incorporating the present invention therein, and FIG. 8 illustrates a signal bearing medium 800 (e.g., storage medium) for storing steps of a program of a method according to the present invention.

FIG. 7 illustrates a typical hardware configuration of an information handling/computer system for use with the invention and which preferably has at least one processor or central processing unit (CPU) 711.

The CPUs 711 are interconnected via a system bus 712 to a random access memory (RAM) 714, read-only memory (ROM) 716, input/output (I/O) adapter 718 (for connecting peripheral devices such as disk units 721 and tape drives 740 to the bus 712), user interface adapter 722 (for connecting a keyboard 724, mouse 726, speaker 728, microphone 732, and/or other user interface device to the bus 712), a communication adapter 734 for connecting an information handling system to a data processing network, the Internet, an Intranet, a personal area network (PAN), etc., and a display adapter 736 for connecting the bus 712 to a display device 738 and/or printer 739.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 711, as represented by the fast-access storage for example. Alternatively, the instructions may be contained in another signal-bearing media, such as a data storage disk/diskette 800 (FIG. 8), directly or indirectly accessible by the CPU 711.

Whether contained in the disk/diskette 800, the computer/CPU 711, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A method for identifying an impact of a business action on a company at an unspecified time point within a predetermined time period, comprising:
analyzing a plurality of example companies taking said business action,
wherein said analyzing is based on features of said plurality of companies in a predetermined pre-action time period and a predetermined post-action time period.

2. The method according to claim 1, wherein said analyzing comprises:
extracting said features for said plurality of example companies in said predetermined pre-action time period and said predetermined post-action time period based on analysis of a metric of said plurality of example companies.

3. The method according to claim 1, wherein said analyzing comprises at least one of:
determining, based on a mathematical algorithm, a feature value indicative of said impact in said predetermined post-action time period;
determining, based on a mathematical model, said impact of said action on said set of companies using a comparison between said feature value in said post-action time period and another feature value in said pre-action time period; and
determining, based on a mathematical algorithm, a time point at which said comparison between said feature value is computed.

4. The method according to claim 1, further comprising:
based on said analyzing, predicting said impact of said business action on said company.

5. The method according to claim 1, further comprising:
predicting, based on a in a thematical model, said impact of said business action on said company.

6. The method according to claim 1, wherein said analyzing comprises:
identifying said plurality of example companies taking said business action; and
for each of said plurality of example companies, identifying a date on which said business action occurred.

7. The method according to claim 1, wherein said company comprises a plurality of companies.

8. The method according to claim 1, wherein said business action comprises a plurality of business actions.

9. The method according to claim 1, wherein said predetermined post-action time period is based on a nature of said business action.

10. The method according to claim 1, further comprising:
for each example company of said plurality of example companies, during a pre-action time period and a post-action time period, constructing a set of features;
said method further comprising at least one of:
determining, based on a mathematical algorithm, a most substantive change in a metric of one of said example companies from said pre-action time period to said post-action time period;
constructing a mathematical model for assessing a significance of said most substantive change and for predicting a size of said most substantive change as a function of a plurality of predetermined factors; and
determining, based on a mathematical algorithm, a time point at which said most substantive change in said metric is computed.

11. The method according to claim 1, further comprising:
identifying a known impact of said business action on said company; and
identifying a known point in time at which said known impact was realized;
said method further comprising at least one of:
determining, based on a mathematical model, a starting point of said business action by said company using a comparison between a feature value in said post-action time period and another feature value in said pre-action time period; and
determining, based on a mathematical model, a significance of said starting point of said business action by said company on said impact to said company.

12. The method according to claim 3, wherein said feature value indicative of said impact comprises:
a feature value indicative of at least one of a maximum impact and a minimum impact in said predetermined post-action time period.

13. The method according to claim 2, wherein said metric comprises at least one of a financial metric, a business metric, a management change, a merger, an acquisition, an earnings pre-announcement, a divestiture, a share repurchase, an expansion, a new market, a layoff, a reorganization, a restructuring, an initial public offering, a litigation, a governmental probe, a Securities and Exchange Commission (SEC) probe, and a regulatory probe.

14. A method for identifying an impact of a business action on a set of companies over a predetermined time period, comprising:
extracting features for a plurality of example companies in a predetermined pre-action time period and a predetermined post-action time period based on an analysis of metrics of said plurality of companies; and
determining, based on a mathematical algorithm, a feature value indicative of an impact in said predetermined post-action time period; and
determining, based on a mathematical model, said impact of said action on said plurality of example companies using a comparison between said feature value in said post-action time period and another feature value in said pre-action time period;
said method further comprising at least one of:
predicting, based on a mathematical model, an impact of said business action on said company; and
predicting, based on a mathematical model, an impact timing of said impact on said company.

15. The method according to claim 14, wherein said company comprises a plurality of new companies.

16. The method according to claim 14, wherein said metrics comprise at least one of a financial metric, a business metric, a management change, a merger, an acquisition, an earnings pre-announcement, a divestiture, a share repurchase, an expansion, a new market, a layoff, a reorganization, a restructuring, an initial public offering, a litigation, a governmental probe, a Securities and Exchange Commission (SEC) probe, and a regulatory probe.

17. The method according to claim 14, further comprising:
identifying said plurality of example companies taking said business action; and
for each of said plurality of example companies, identifying a date on which said business action occurred.

18. The method according to claim 14, wherein said predetermined pre-action time window comprises a plurality of financial quarters prior to a financial quarter in which said action occurred.

19. The method according to claim 14, wherein said predetermined post-action time window comprises a plurality of financial quarters subsequent to a financial quarter in which said action occurred.

20. The method according to claim 14, wherein said predetermined post-action time window comprises a plurality of financial quarters subsequent to a transition period following a financial quarter in which said action occurred.

21. The method according to claim 14, wherein a transition period follows a financial quarter in which said action occurred.

22. The method according to claim 21, wherein said transition period comprises a predetermined period of time, based on said action, in which no impact of said action occurs.

23. The method according to claim 14, wherein at least one of said mathematical models is designed by applying at least one of a statistical learning approach and a machine learning approach based on said set of example companies.

24. The method according to claim 15, further comprising:
extracting, based on a predetermined date for at least one of a planned action and an expected action for said plurality of companies, a same set of features as said plurality of example companies;
applying a mathematical model to said extracted same set of features; and
predicting, for each company of said plurality of companies, at least one of an expected impact of said action, an expected time of said expected impact of said action, and an expected size of said expected impact of said action, for each feature of said set of features.

25. The method according to claim 24, further comprising:
sorting said plurality of example companies based on at least one of said expected impact, said expected time, and said expected size.

26. The method according to claim 24, wherein said plurality of predetermined factors comprises at least one of a pre-action factor, a company specific factor, and an action-specific factor.

27. A system of identifying an impact of a business action on a company at an unspecified time point within a predetermined time period, comprising:
an extractor that extracts features of a plurality of example companies in a predetermined pre-action time period and a predetermined post-action time period based on analysis of metrics of said plurality of example companies;
said system further comprising at least one of:
a determiner that determines, based on a mathematical algorithm, a feature value indicative of an impact in said predetermined post-action time period;
a determiner that determines, based on a mathematical model, said impact of said action on said plurality of example companies based on a comparison between said feature value in said post-action time period and another feature value in said pre-action time period to determine;
a predictor that predicts, based on a mathematical model, an impact of said business action on said company; and
a predictor that predicts, based on a mathematical model, a timing of said impact of said business action on said company.

28. The system according to claim 27, further comprising:
an identifier that identifies said plurality of example companies taking said business action and, for each of said plurality of example companies, identifies a date on which said business action occurred.

29. A system of identifying an impact of a business action on a company at an unspecified time point within a predetermined time period, comprising:
an extractor that extracts features of a plurality of example companies in a predetermined pre-action time period and a predetermined post-action time period based on analysis of metrics of said plurality of example companies;
an identifying unit that identifies at least one of a known impact of said business action on said company and a known point in time at which said known impact was realized; and
a determiner unit that at least one of:
determines, based on a mathematical model, a starting point of said business action by said company using a comparison between a feature value in said post-action time period and another feature value in said pre-action time period; and
determines, based on a mathematical model, a significance of said starting point of said business action by said company on said impact to said company.

30. A system of identifying an impact of a business action on a company at an unspecified time point within a predetermined time period, comprising:
means for extracting features of a plurality of example companies in a predetermined pre-action time period and a predetermined post-action time period based on analysis of metrics of said plurality of example companies;
said system further comprising at least one of:
means for determining, based on a mathematical algorithm, a feature value indicative of an impact in said predetermined post-action time period;
means for determining, based on a mathematical model, said impact of said action on said plurality of example companies based on a comparison between said feature value in said post-action time period and another feature value in said pre-action time period to determine;
means for predicting, based on a mathematical model, an impact of said business action on said company; and
means for predicting, based on a mathematical model, a timing of said impact of said business action on said company.

31. A system of identifying an impact of a business action on a company at an unspecified time point within a predetermined time period, comprising:
means for extracting features of a plurality of example companies in a predetermined pre-action time period and a predetermined post-action time period; and
means for analyzing a plurality of example companies taking said business action based on said features of said plurality of companies in said predetermined pre-action time period and said predetermined post-action time period.

32. A signal-bearing medium tangibly embodying a program of machine-readable instructions executable by a digital processing apparatus to perform a method for identifying an impact of a business action on a company at an unspecified time point within a predetermined time period, the method comprising:
analyzing a plurality of example companies taking said business action,
wherein said analyzing is based on features of said plurality of companies in a predetermined pre-action time period and a predetermined post-action time period.

33. A method for deploying computing infrastructure in which computer-readable code is integrated into a computing system, and combines with said computing system to perform a method for identifying an impact of a business action on a company at an unspecified time point within a predetermined time period, the method comprising:
analyzing a plurality of example companies taking said business action,
wherein said analyzing is based on features of said plurality of companies in a predetermined pre-action time period and a predetermined post-action time period.
